(19) United States
(12) Patent Application Publication
(10) Pub. No.: US 2018/0247644 A1
(43) Pub. Date: Aug. 30, 2018

(54) QUEUEING SPOKEN DIALOGUE OUTPUT

(71) Applicant: Intel Corporation, Santa Clara, CA (US)

(72) Inventors: Robert Jim Firby, Santa Clara, CA (US); Lavinia Andreea Danielescu, Santa Clara, CA (US); Blake D. Ward, Durango, CO (US); Beth Ann Hockey, Sunnyvale, CA (US); Jessica Gwen Christian, Redwood City, CA (US)

(21) Appl. No.: 15/443,723

(22) Filed: Feb. 27, 2017

(51) Int. Cl. G10L 15/22; G10L 15/14; G10L 15/18; G10L 13/08; G10L 13/04

(52) U.S. Cl. CPC G10L 15/22; G10L 15/14; G10L 2015/223; G10L 13/08; G10L 13/04; G10L 15/18

(57) ABSTRACT

Various systems and methods for queueing spoken dialogue output are provided herein. A system for queueing spoken dialogue output includes a memory device including a queue, and an output manager to: determine a relation between a first utterance and a second utterance in the queue; assign a revision strategy based on the relation; and apply the revision strategy to the queue, the queue used to provide spoken dialogue output to a user.

### TECHNICAL FIELD

Embodiments described herein generally relate to speech synthesis systems and in particular to queueing spoken dialogue output.

### BACKGROUND

Natural language interfaces are becoming commonplace in computing devices generally, and particularly in mobile computing devices, such as smartphones, tablets, and laptop computers. Some implementations provide a digital assistant where the user is able to ask a question and receive a response from the digital assistant. Other implementations are more complex and attempt to provide multi-faceted conversation.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic diagram illustrating a dialogue system 100, according to an embodiment;

FIG. 2 is a schematic diagram illustrating an output manager 106, according to an embodiment;

FIG. 3 is a schematic diagram illustrating a process to revise output queue, according to an embodiment;

FIG. 4 is a flowchart illustrating a method for managing a spoken dialogue output queue, according to an embodiment; and

FIG. 5 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Dialogue systems for activities such as tutoring, coaching and training, are mixed initiative; these systems initiate interactions with the user by offering expert information at appropriate points in the conversation as well as responding to user queries or requests. This behavior differs from more basic question-answer systems where the user initiates interaction and the system merely responds to the user query or command.

Mixed initiative systems may use a large range of inputs, such as sensor data, user quiz results, user questionnaires, partial problem solutions, and user responses to an existing or previous conversation with the system. The inputs may be used to trigger system-provided information. Information may be provided in response to a query, condition, or context related to the conversation between the user and the system. Alternatively, information may be offered at timed intervals or on another schedule.

In mixed initiative tutoring/coaching/training dialogue systems the potential material to be communicated to the user comes from both the expert component and from the dialogue system's reasoning about what is needed in the conversational interaction with the user. Due to the multiple sources of system output speech, and because it is important for these types of systems to provide a natural, conversational experience to the user, constructing, organizing and prioritizing the dialogue system's output queue is an important problem.

Disclosed herein are systems and methods that provide queueing of spoken dialogue output. The dialogue system may have multiple sources of output material, such as an expert system to provide insightful commentary or advice and a notification system to alert a user of a situation or condition. Based on various factors and conditions, multiple utterances may be queued up to be presented to the user during a conversation. Some of the queued utterances may become irrelevant, redundant, or less important by the time they reach the front of the queue, while other utterances later in the queue may become more important, relevant, or material as the conversation progresses. As such, what is needed is a system to dynamically adjust the queued utterances to ensure that the most relevant, helpful, useful, or material information is presented to the user in a timely, digestible manner.

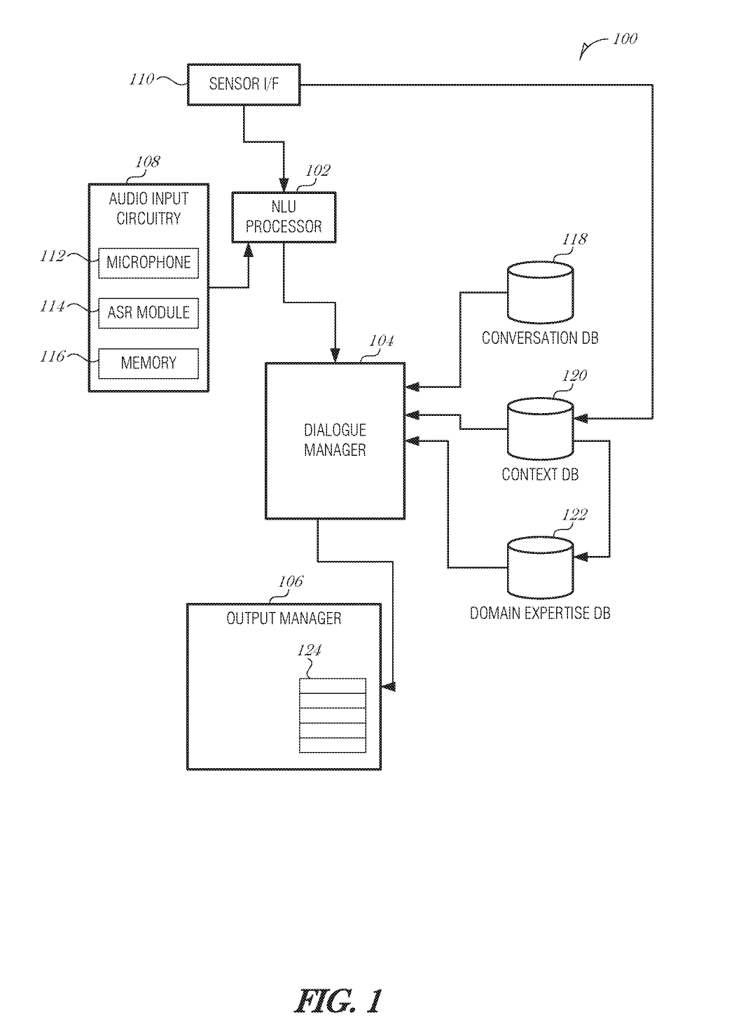

FIG. 1 is a schematic diagram illustrating a dialogue system 100, according to an embodiment. The dialogue system 100 may be incorporated into a server computer, desktop computer, laptop, wearable device, hybrid device, or other compute device capable of receiving and processing conversation data.

The dialogue system 100 includes a natural language understanding (NLU) processor 102, a dialogue manager 104, and an output manager 106. The NLU processor 102 receives data from audio input circuitry 108 and sensor interface 110. The audio input circuitry 108 may include a microphone 112 to capture spoken user utterances, an automatic speech recognition (ASR) module 114 to convert the perceived utterances to text, and memory 116 for temporary storage during processing the captured utterances. Alternatively, the input may be provided using other modes, such as with a keyboard, mouse, digitized tablet, etc. When other modalities are used for user input, the processing to text is suitably modified and incorporated into the dialogue system 100. For instance, if text is typed in by the user, then the audio input circuitry 108 is not needed, and instead the NLU processor 102 may act on the provided text.

The automatic speech recognition module 114 is used to analyze a person's voice and recognize terms in the speech. More specifically, the automatic speech recognition module 114 is used to receive an input audio waveform and convert the audio wave form of input speech to input text. Speech recognition may be implemented in a variety of ways, including with Hidden Markov Models combined with feedforward artificial neural networks (ANN), a long short-term memory recurrent neural network, and other types of machine learning or artificial intelligence.

The sensor interface 110 may be connected to or receive data from one or more sensors. Sensors include, but are not limited to biometric sensors and environmental sensors. Biometric sensors include devices like a heart rate monitor, a heart rate variability monitor, a posture sensor, an activity sensor, a thermometer, a camera (visible light, infrared, etc.), a microphone, a power sensor (e.g., to measure how much energy the user is outputting), an altitude sensor (e.g., if the user is climbing or descending), a stride analyzer (e.g., to measure rate, length, or other aspects of a running or walking stride), or the like. Environmental sensors include devices like photodetectors, cameras, humidity sensors, thermometers, pressure sensors, microphones, global positioning system (GPS) devices, or the like. Biometric and environmental sensors may include or be composed of accelerometers, gyrometers, orientation sensors, magnetometers. vibration sensors, or other general purpose sensors.

Using the text provided by the audio input circuitry 108 and the sensor data provided by sensor interface 110, the NLU processor 102 is configured, programmed, or otherwise able to interpret the user's utterances for further processing. Natural language understanding is a subtopic of natural language processing (NLP). Where NLP focuses on a wide array of human-computer interaction, NLU focuses on the area of how a computer derives meaning from user interactions. The NLU processor 102 may be implemented using a parser and grammar rules to break sentences into internal representations, which are then processed using a semantic analysis technique to derive the meaning of the content. Analysis using logical rules may also be used to further develop the meaning.

The NLU processor 102 provides its output to the dialogue manager 104. The dialogue manager 104 uses a variety of available information sources along with the interpretation of the user's utterance provided by the NLU processor 102, to produce a conversational output utterance for the dialogue system 100. The available information sources may include a conversation database 118, context database 120, and domain expertise database 122.

The conversation database 118 may include information about the current and previous conversations conducted with the present user. The conversation database 118 may also include grammar, semantics, and other information about how conversations are structured.

The context database 120 may provide various information to the dialogue manager 104, such as the time of day, the type of activity that the user is engaged in (e.g., sleeping, watching TV, exercising, driving, etc.), the user's location (e.g., in an elevator, in an office, on a subway car, etc.), the user's appointment schedule, whether other people are in vicinity of the conversation, and the like. The context database 120 may derive some contextual information from sensor data provided by the sensor interface 110.

The domain expertise database 122 includes information about one or more areas of practice, knowledge, or activity. Example domain expertise databases 122 include, but are not limited to a running coach database, a workout coach database, a tennis instructor database, a rally car driver database, a chess player database, a Cajun cooking database, a watercolor painting database, or the like. The domain expertise database 122 may interface with the sensor interface 110 to obtain sensor data. The domain expertise database 122 may also interface with the context database 120 to obtain contextual data. Using internal data and optional data from various sources, the domain expertise database 122 provides information to the dialogue manager 104 to produce domain expertise output utterances.

In a coaching example, the domain expertise database 122 may identify that the runner is using an inefficient stride length during a training run. The domain expertise database 122 may then determine an advice utterance and provide it to the dialogue manager 104. The dialogue manager 104 may construct the output format of the advice utterance according to conversation standards. For instance, the advice utterance may be initially presented by the domain expertise database 122 as “incorrect form; stride length too long.” The dialogue manager 104 may process the initial utterance, formatting it to fit into a conversation, for example “John. your stride length is too long.”

As another coaching example, the domain expertise database 122 may be configured to provide periodic or regular feedback to the user. For instance, the domain expertise database 122 may provide an estimated number of calories burned, a number of miles (or portion thereof) traversed, a number of exercise repetitions performed or remaining in a set, or a timer alarm indicating the end of a session or circuit. The domain expertise database 122 may pass an initial informational utterance to the dialogue manager 104, which may then reformat the utterance to one that fits the conversation, such as “Good job John! You've run over two miles! Keep going!”

The conversation produced by dialogue manager 104 may be modified or influenced using various external factors, such as the age of the user, the cultural background of the user, the geographic location of the conversation, the time of day, and the like. External factors may be obtained from sensors via sensor interface 110, by context database 120, or elsewhere. Age and cultural background may be detected using image processing on one or more images of the user's face, clothing, skin color, or other characteristics. Cultural background may be detected, at least in part, based on audio samples of the user's voice to determine accents. Alternatively, the cultural background may be inferred from the language chosen by the user for the speech output (e.g., if the user chooses “French” as the output language, then the inference is that the user has a French background or culture). Geographic location may be determined with a location sensor, such as a global positioning system (GPS) unit. Alternatively, one or more of these types of user characteristics may be input or provided by the user and stored or accessed by the context database 120.

Using external factors, the conversation may be more tailored for the user. For example, conversations with elderly people may be presented with a different cadence, using different terms, and with a different computer voice than conversations held with a young adult. As another example, conversations held in the middle of the night may be shortened or abbreviated when compared to those conversations held during regular business hours.

The dialogue manager 104 transmits the conversational output utterances and the domain expertise output utterances to the output manager 106. The output manager 106 may queue the utterances in an output queue 124. Utterances may be queued using a first-in-first-out (FIFO) mechanism. Periodically. regularly, or continuously the output manager 106 may inspect the output queue 124 and modify the contents.

It is understood that in some embodiments, the dialogue manager 104 may not receive input from the NLU processor 102. In such embodiments, the dialogue manager 104 may act solely on information provided by the domain expertise database 122. Timed output, output provided in response to a user's activity or lack of activity, output provided to correct a user's action, and other advice or informational outputs may be created or initiated by the domain expertise database 122 and processed by the dialogue manager 104.

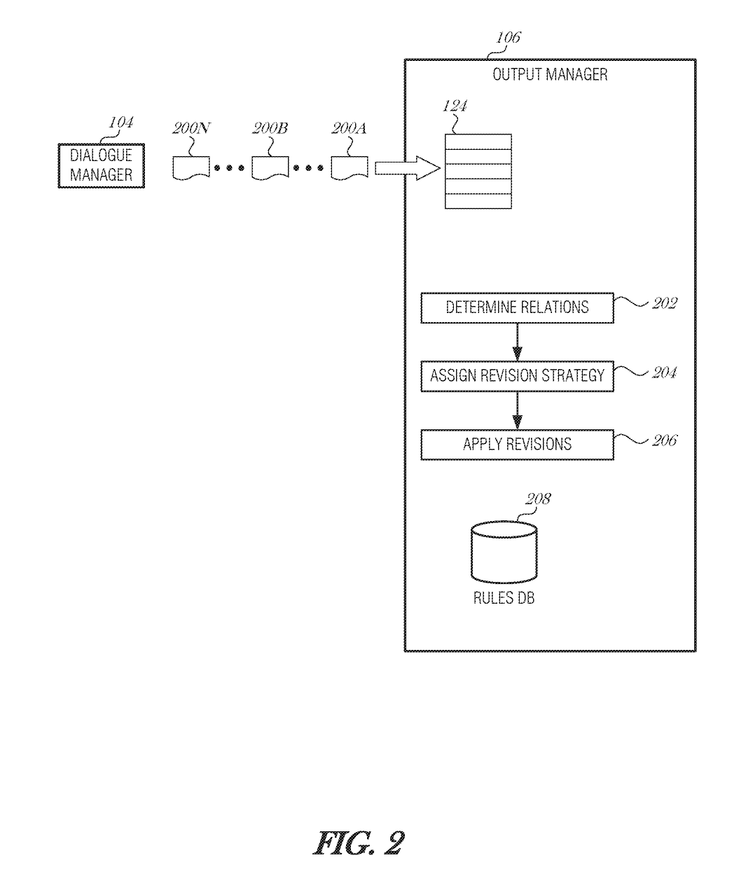

FIG. 2 is a schematic diagram illustrating the output manager 106, according to an embodiment. The output manager 106 receives potential output utterances 200 from the dialogue manager 104. The potential output utterances 200 include utterances originating from the NLU processor 102 and the domain expertise database 122. In addition, the potential output utterances 200 may include other types of utterances, such as a system-based utterance (e.g., a battery low status), which is not a result of a conversation or domain expertise analysis. Such interruption type utterances may be interwoven with other utterances (e.g., potential output utterances 200) to keep the user apprised of status, condition, and other events regarding the dialogue system 100.

The potential output utterances 200 are queued in the output queue 124. The output manager 106 may analyze the queue by first determining relations between items in the output queue 124 (operation 202), assigning a revision strategy to each relation (operation 204), and then applying revisions to the output queue 124 based on the revision strategy (operation 206). The operations 202, 204, 206 are repeated as needed. The operations 202, 204, 206 may be performed after an utterance is queued, after a batch of utterances are queued, regularly, periodically, in response to a triggering event, or otherwise. For instance, the operations 202, 204, 206 may be performed once a second. In another instance, the operations 202, 204, 206 may be performed when the output queue 124 is over half full.

The output manager 106 uses a rules database 208 to control the output queue 124. The rules database 208 may be stored locally or at a remote location or locations (e.g., cloud service). In an example, rules stored in the rules database 208 are formatted as {utterance A, [utterance B], . . . , [utterance N], relation, action}, where utterance A, utterance B, . . . , utterance N are the utterances that are queued in the output queue 124, relation refers to how the utterances are related to one another or to other conditions, and action is the revision strategy with the resulting action based on the result of the relation. Example relations include, but are not limited to “is irrelevant”, “is a subset”, “is a superset of”, “is equivalent”, “is scheduled to be delivered before”, “is scheduled to be delivered after”, “is redundant”, and “should be merged with”.

As a first example, the queued utterance may be a timed utterance from a coaching application, such as “You have 30 seconds left in your workout!” If the utterance is deprioritized several times, such that it is not queued to be presented until after the workout has ended, the output manager 106 may determine that the relation of the utterance is “is redundant” and the resulting action (e.g., revision strategy) is DELETE.

As a second example, there may be two queued utterances A and B, where utterance A is a timed utterance from a coaching expert system of “You have 30 seconds in your workout!” and utterance B is a response to a user query of how much time is left in the workout. The output manager 106 may determine that utterance A and utterance B have a relation of “is redundant” or “should be merged” and the resulting action may be DELETE utterance A, resulting in a single response to the user query, or MERGE utterances, resulting in a new utterance, such as “There are 30 seconds left in your workout!”

As a third example, utterance A may be a triggered output including subject matter of K, L, and M. Utterance B may be a response to a user query only include subject matter related to K. The output manager 106 may determine that the relation between utterance A and B is “is a superset of” and the resulting action is DELETE utterance B, or MERGE utterances so that the user doesn't think that the system ignored or missed the query.

As a fourth example, the context of the user may have changed while the utterance is in queue. The user may have changed exercises, for example, or modes of transportation, or a destination of travel, or a topic of conversation, etc. In this type of situation, the output manager 106 may determine that a particular utterance has a relation of “is irrelevant” to the user's current context, and set a resulting action of DELETE.

It is understood that the relations and actions presented here are non-limiting. One of ordinary skill would be able to develop relations for one, two, three, or more utterances, and resulting actions that may be simple or compound actions on one or more utterances. Actions may include operation of DELETE, MODIFY, MERGE, MOVE Ind. QUEUE, and the like. The actions may be referred to as a revision strategy.

The algorithms for analyzing relations and assigning revision actions may be implemented in several ways including: heuristic rule based, logic based, statistical, or hybrids rule based and statistical methods. Identification of relations and patterns of preferred assignments of revisions may be learned from data (e.g., trained).

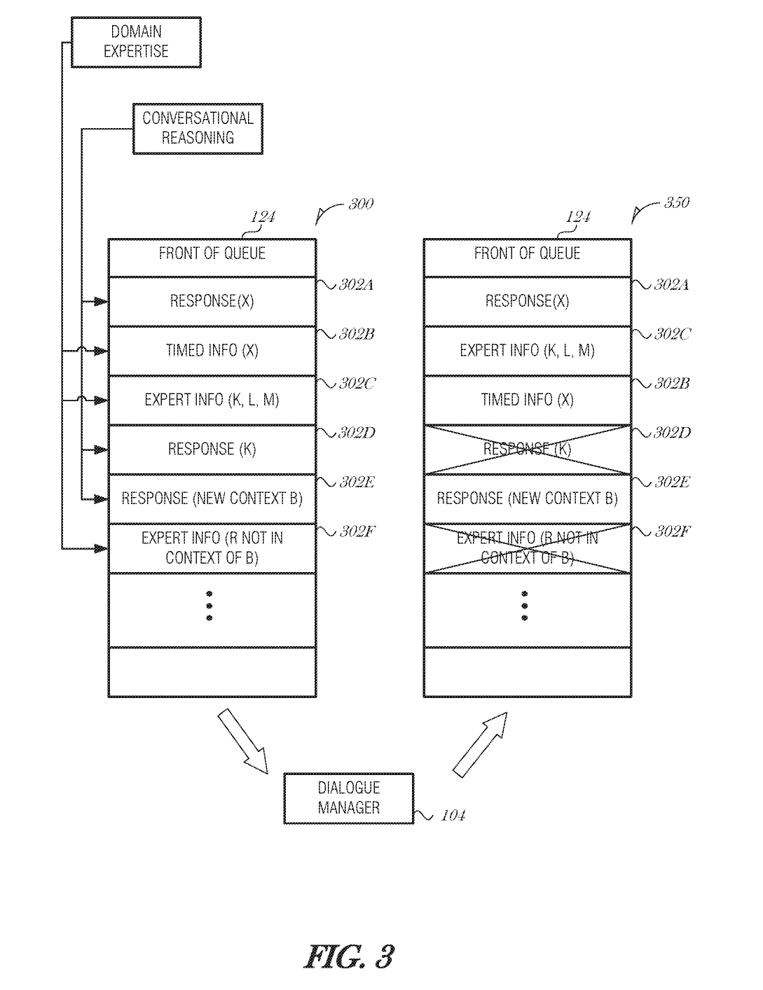

FIG. 3 is a schematic diagram illustrating a process to revise output queue 124, according to an embodiment. The output queue 124 is shown in a first state 300. In the first state 300, the output queue 124 has six utterances 302A, 302B, 302C, 302D, 302E, 302F (collectively referred to as 302A-F) queued. The utterances 302A-F represent utterances derived from conversational reasoning (302A, 302D, 302E; referred to as 302ADE) and utterances derived from domain expertise processing (302B, 302C, 302F; referred to as 302BCF). The utterances 302ADE include responses to user queries made during the course of one or more conversations. The utterances 302BCF include timed, context-driven, or spontaneous utterances from the domain expertise database 122, which may be modified by the dialogue manager 104.

The example in FIG. 3 illustrates the revisions that are executed on a queue based on the relations between the items, and other factors that are important to relevance including, but not limited to proximity, timing, and desired level of conciseness for the system.

For utterances 302A. 302B, the content of the two is the same (e.g., “X”), although their source and ordering are not the same. Content “X” may be, for example in a coaching application, a semi-regular report of metrics such as speed or distance. The user may also request similar metrics, and the system would prepare a response (e.g., response 302A). In the example illustrated, because the response and the timed info are equivalent, saying both is redundant. The revision strategy assigned to the relation between utterances 302A and 302B is to push the redundant time info response 302B to later in the output queue 124.

However, when the time info response 302B is pushed to later in the output queue 124, in some cases, the information in info response 302B may be updated. For instance, in the example illustrated, if the info response 302B is a specific metric (e.g., “You have 3:00 minutes left in your workout”) and the response 302B is pushed to ten seconds later, the metric should be updated to reflect the correct metric (e.g., correct remaining time of 2:50 minutes). In other instances though. the info response 302B may be something that is not strictly time related, e.g., “You are doing great, keep it up!”, in which case, the utterance in info response 302B is not updated. Thus, for certain metrics, the info response 302B is revised with updated metrics so that when it is output, the metrics are still accurate, and in some embodiments, a revision strategy includes updating the associated information of one or more utterances, in addition to rearranging the output of one or more utterances.

For utterances 302C and 302D, the content of utterance 302D (content K) is a subset of the content in utterance 302C (content K, L. M). Since the expertise triggered utterance 302C has more content and is scheduled to be produced sooner than the response utterance 302D, the assigned revision strategy is to drop the response utterance 302D from the output queue 124.

Utterance 302E represents the user introducing a new goal or a new context. Suppose the user wants to stop a workout and issues a voice command as part of a conversation, “Stop workout.” The utterance 302E may be a confirmatory response to the change in context. Utterance 302F represents an utterance related to a prior goal (e.g., content R), for example telling the user to increase their pace for the rest of the workout. These are incompatible so the assigned revision strategy is to drop the utterance 302F, which no longer is relevant to the current goal (B).

The output queue 124 is reordered and revised to a second state 350 by the dialogue manager 104. The relations between output items and queue revision strategies are not limited to those shown in the example in FIG. 3. The revision strategies may also include removing two outputs that essentially cancel each other (e.g., in a coaching application: pause workout, followed by a resume workout), discarding time sensitive outputs if they cannot be acted on quickly enough, or merging similar outputs (e.g. in a coaching application: if a request for current speed is followed by a request for power output, the two pieces of information may be combined into a single output sentence that is more natural).

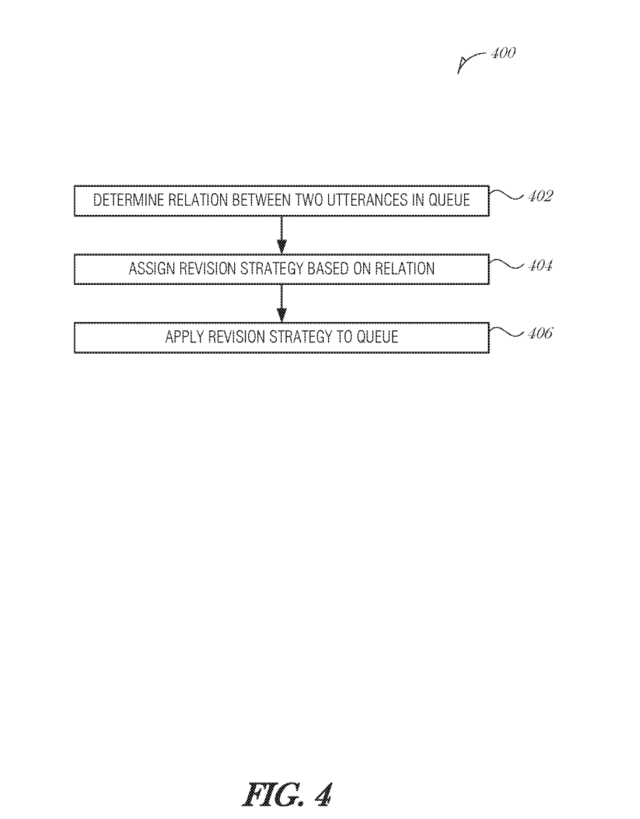

FIG. 4 is a flowchart illustrating a method 400 for managing a spoken dialogue output queue, according to an embodiment. At block 402, a relation between a first utterance data and a second utterance data in a queue is determined. Utterance data may refer to the utterance (e.g., a string variable with the phrase encoded in the variable), a reference to the utterance (e.g., a pointer to a memory location, or a code with a relationship to the utterance), or other data corresponding to the utterance may be used as audible output.

In an embodiment, determining the relation between the first and second utterance data in the queue comprises accessing a training set to identify a relation between two utterance data. In an embodiment, determining the relation between the first and second utterance data in the queue comprises using a heuristic rule based analysis to determine the relation between two utterance data. In an embodiment, determining the relation between the first and second utterance data in the queue comprises using a statistical analysis to determine the relation between two utterance data.

The utterances may be provided by way of speech-to-text, direct text input, domain knowledge, or other sources. Thus, in an embodiment, the method 400 includes processing text to generate the first utterance data and forwarding the first utterance data to the queue. In a further embodiment, the method 400 includes receiving audio data of the user and processing the audio data into the text. In another embodiment, the method 400 includes receiving the text directly from the user as text input. For instance, the user may type in the text using a keyboard. In this case, speech recognition is not needed as the text is directly available. The NLU processor may be used to interpret the provided text and process it to a more normal form.

In another embodiment, the method 400 includes accessing a domain expertise utterance data and adding the domain expertise utterance data to the queue as the first utterance data.

In another embodiment, the method 400 includes accessing sensor data collected at a sensor interface, the sensor interface to collect data from a sensor, generating a response to a user query using the data from the sensor, and queueing the response in the queue as the first utterance data. In a further embodiment, the sensor includes at least one of: a biometric sensor or an environmental sensor.

In various embodiments, the biometric sensor is a heart rate sensor, a posture sensor, a heart rate variability sensor, an activity sensor, a thermometer, or a camera. In various embodiments, the environmental sensor is a photodetector, a camera, a humidity sensor, a pressure sensor, or a global positioning sensor.

In an embodiment, the method 400 includes using data from the sensor to influence the grammar, semantics, or other information about how conversations are structured. In a further embodiment, the data from the sensor indicates an age of the user, and the grammar used in the first utterance data is influenced by the age of the user. In another embodiment, the data from the sensor indicates a cultural background of the user, and the grammar used in the first utterance data is influenced by the cultural background of the user. In a related embodiment, the data from the sensor indicates a geographical location of the user, and the grammar used in the first utterance data is influenced by the geographical location of the user.

At block 404, a revision strategy is assigned based on the relation. In an embodiment, assigning a revision strategy based on the relation includes accessing a rule database, a rule in the rule database including a mapping from a relation to an action; identifying the action corresponding to the relation; and assigning the corresponding action as the revision strategy. In a further embodiment, the relation is that there are redundant utterance data, and wherein the corresponding action is to drop one of the redundant utterance data. In a related embodiment, the relation is that there are similar utterance data, and wherein the corresponding action is to merge the similar utterance data.

At block 406, the revision strategy is applied to the queue, the queue used to provide spoken dialogue output to a user. In an embodiment, applying the revision strategy to the queue comprises removing the first utterance data from the queue when the first utterance data and the second utterance data have substantially equivalent content (or refer to substantially equivalent content). In an embodiment, applying the revision strategy to the queue comprises merging the first and second utterance data into a new utterance data and placing the new utterance data in the queue, when the first and second utterance data have substantially similar content. In an embodiment, applying the revision strategy to the queue comprises removing the first utterance data from the queue when the first utterance data is no longer relevant. In an embodiment, applying the revision strategy to the queue comprises reordering the first utterance data in the queue. In an embodiment, applying the revision strategy to the queue comprises moving the first utterance data to a different position in the queue and modifying the first utterance data to be consistent with when the first utterance data will be output based on the different position in the queue.

In an embodiment, the method 400 includes accessing a conversation database to assist in constructing the first utterance data consistent with conversational form. In a further embodiment, the conversation database includes grammar, semantics, or other information about how conversations are structured.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instructions on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC). system on-chip (SoC), desktop computers, laptop computers, tablet computers, servers, smart phones, etc.

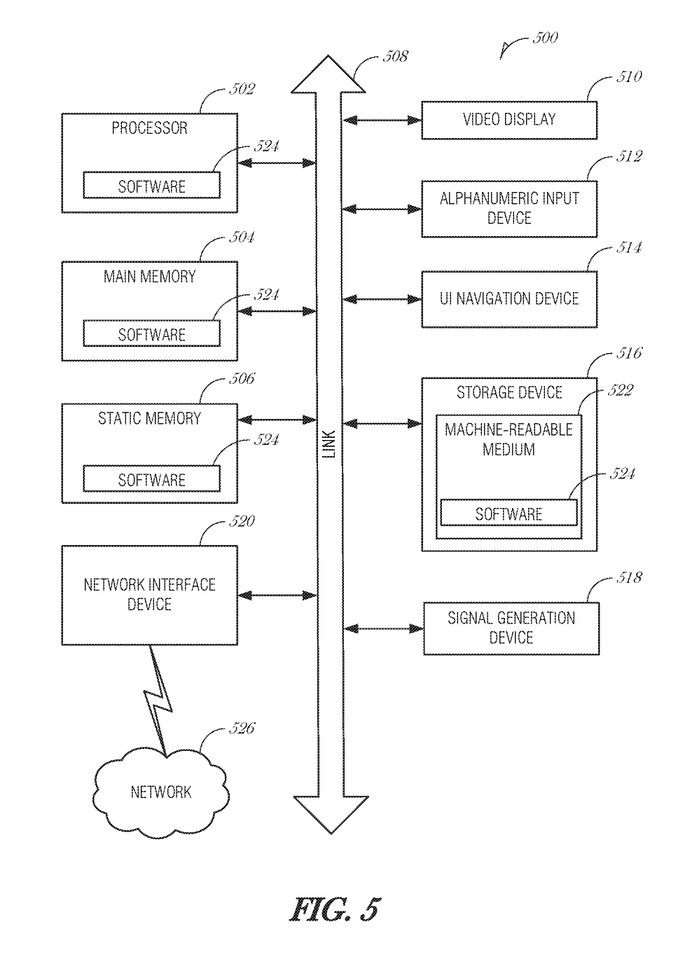

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506. which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, gyrometer, magnetometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506. and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM). electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Network interface device 520 may be configured or programmed to implement the methodologies described herein. In particular, the network interface device 520 may provide various aspects of packet inspection, aggregation, queuing, and processing. The network interface device 520 may also be configured or programmed to communicate with a memory management unit (MMU), processor 502, main memory 504, static memory 506, or other components of the system 500 over the link 508. The network interface device 520 may query or otherwise interface with various components of the system 500 to inspect cache memory; trigger or cease operations of a virtual machine, process, or other processing element; or otherwise interact with various computing units or processing elements that are in the system 500 or external from the system 500.

### Additional Notes & Examples

Example 1 is a system for queueing spoken dialogue output, the system comprising: a memory device including a queue; and an output manager to: determine a relation between a first utterance data and a second utterance data in the queue; assign a revision strategy based on the relation; and apply the revision strategy to the queue, the queue used to provide spoken dialogue output to a user.

In Example 2, the subject matter of Example 1 optionally includes a dialogue manager to: access a domain expertise utterance data; and add the domain expertise utterance data to the queue as the first utterance data.

In Example 3, the subject matter of any one or more of Examples 1-2 optionally include a dialogue manager to: process text received from a natural language understanding processor to generate the first utterance data; and forward the first utterance data to the queue.

In Example 4, the subject matter of Example 3 optionally includes wherein the text is directly received from the user as text input.

In Example 5, the subject matter of any one or more of Examples 3-4 optionally include the natural language understanding processor to receive audio data of the user and process the audio data into the text.

In Example 6, the subject matter of Example 5 optionally includes wherein the natural language processor is to: access sensor data collected at a sensor interface, the sensor interface to collect data from a sensor; and generate a response to a user statement using the data from the sensor.

In Example 7, the subject matter of Example 6 optionally includes wherein the sensor includes at least one of: a biometric sensor or an environmental sensor.

In Example 8, the subject matter of Example 7 optionally includes wherein the biometric sensor is a heart rate sensor.

In Example 9, the subject matter of any one or more of Examples 7-8 optionally include wherein the biometric sensor is a posture sensor.

In Example 10, the subject matter of any one or more of Examples 7-9 optionally include wherein the biometric sensor is a heart rate variability sensor.

In Example 11, the subject matter of any one or more of Examples 7-10 optionally include wherein the biometric sensor is an activity sensor.

In Example 12, the subject matter of any one or more of Examples 7-11 optionally include wherein the biometric sensor is a thermometer.

In Example 13, the subject matter of any one or more of Examples 7-12 optionally include wherein the biometric sensor is a camera.

In Example 14, the subject matter of any one or more of Examples 7-13 optionally include wherein the environmental sensor is a photodetector.

In Example 15, the subject matter of any one or more of Examples 7-14 optionally include wherein the environmental sensor is a camera.

In Example 16. the subject matter of any one or more of Examples 7-15 optionally include wherein the environmental sensor is a humidity sensor.

In Example 17, the subject matter of any one or more of Examples 7-16 optionally include wherein the environmental sensor is a pressure sensor.

In Example 18, the subject matter of any one or more of Examples 7-17 optionally include wherein the environmental sensor is a global positioning sensor.

In Example 19. the subject matter of any one or more of Examples 7-18 optionally include wherein the dialogue manager uses data from the sensor to influence the grammar, semantics, or other information about how conversations are structured.

In Example 20, the subject matter of Example 19 optionally includes wherein the data from the sensor indicates an age of the user, and wherein the grammar used in the first utterance data is influenced by the age of the user.

In Example 21, the subject matter of any one or more of Examples 19-20 optionally include wherein the data from the sensor indicates a cultural background of the user, and wherein the grammar used in the first utterance data is influenced by the cultural background of the user.

In Example 22, the subject matter of any one or more of Examples 19-21 optionally include wherein the data from the sensor indicates a geographical location of the user, and wherein the grammar used in the first utterance data is influenced by the geographical location of the user.

In Example 23, the subject matter of any one or more of Examples 1-22 optionally include a dialogue manager to: access a conversation database to assist in constructing an output utterance data consistent with conversational form.

In Example 24, the subject matter of Example 23 optionally includes wherein the conversation database includes grammar, semantics, or other information about how conversations are structured.

In Example 25, the subject matter of any one or more of Examples 1-24 optionally include wherein to determine the relation between the first and second utterance data in the queue, the output manager is to access a training set to identify a relation between two utterance data.

In Example 26, the subject matter of any one or more of Examples 1-25 optionally include wherein to determine the relation between the first and second utterance data in the queue, the output manager is to use a heuristic rule based analysis to determine the relation between two utterance data.

In Example 27, the subject matter of any one or more of Examples 1-26 optionally include wherein to determine the relation between the first and second utterance data in the queue, the output manager is to use a statistical analysis to determine the relation between two utterance data.

In Example 28, the subject matter of any one or more of Examples 1-27 optionally include wherein to assign a revision strategy based on the relation, the output manager is to: access a rule database, a rule in the rule database including a mapping from a relation to an action; identify the action corresponding to the relation; and assign the corresponding action as the revision strategy.

In Example 29, the subject matter of Example 28 optionally includes wherein the relation is that there are redundant utterance data, and wherein the corresponding action is to drop one of the redundant utterance data.

In Example 30, the subject matter of any one or more of Examples 28-29 optionally include wherein the relation is that there are similar utterance data, and wherein the corresponding action is to merge the similar utterance data.

In Example 31, the subject matter of any one or more of Examples 1-30 optionally include wherein to apply the revision strategy to the queue, the output manager is to remove the first utterance data from the queue when the first and second utterance data have substantially equivalent content.

In Example 32, the subject matter of any one or more of Examples 1-31 optionally include wherein to apply the revision strategy to the queue, the output manager is to merge first and the second utterance data into a new utterance data and place the new utterance data in the queue, when the first and the second utterance data have substantially similar content.

In Example 33, the subject matter of any one or more of Examples 1-32 optionally include wherein to apply the revision strategy to the queue, the output manager is to remove the first utterance data from the queue when the first utterance data is no longer relevant.

In Example 34, the subject matter of any one or more of Examples 1-33 optionally include wherein to apply the revision strategy to the queue, the output manager is to reorder the first utterance data in the queue.

In Example 35, the subject matter of any one or more of Examples 1-34 optionally include wherein to apply the revision strategy to the queue, the output manager is to move the first utterance data to a different position in the queue and modify the first utterance data to be consistent with when the first utterance data will be output based on the different position in the queue.

Example 36 is a method of queueing spoken dialogue output, the method comprising: determining a relation between a first utterance data and a second utterance data in a queue; assigning a revision strategy based on the relation; and applying the revision strategy to the queue, the queue used to provide spoken dialogue output to a user.

In Example 37, the subject matter of Example 36 optionally includes processing text to generate the first utterance data; and forwarding the first utterance data to the queue.

In Example 38, the subject matter of Example 37 optionally includes receiving audio data of the user and processing the audio data into the text.

In Example 39, the subject matter of any one or more of Examples 37-38 optionally include receiving the text directly from the user as text input.

In Example 40, the subject matter of any one or more of Examples 36-39 optionally include accessing a domain expertise utterance data; and adding the domain expertise utterance data to the queue as the first utterance data.

In Example 41, the subject matter of any one or more of Examples 36-40 optionally include accessing sensor data collected at a sensor interface, the sensor interface to collect data from a sensor; generating a response to a user query using the data from the sensor; and queueing the response in the queue as the first utterance data.

In Example 42, the subject matter of Example 41 optionally includes wherein the sensor includes at least one of: a biometric sensor or an environmental sensor.

In Example 43, the subject matter of Example 42 optionally includes wherein the biometric sensor is a heart rate sensor.

In Example 44, the subject matter of any one or more of Examples 42-43 optionally include wherein the biometric sensor is a posture sensor.

In Example 45, the subject matter of any one or more of Examples 42-44 optionally include wherein the biometric sensor is a heart rate variability sensor.

In Example 46, the subject matter of any one or more of Examples 42-45 optionally include wherein the biometric sensor is an activity sensor.

In Example 47, the subject matter of any one or more of Examples 42-46 optionally include wherein the biometric sensor is a thermometer.

In Example 48, the subject matter of any one or more of Examples 42-47 optionally include wherein the biometric sensor is a camera.

In Example 49. the subject matter of any one or more of Examples 42-48 optionally include wherein the environmental sensor is a photodetector.

In Example 50, the subject matter of any one or more of Examples 42-49 optionally include wherein the environmental sensor is a camera.

In Example 51, the subject matter of any one or more of Examples 42-50 optionally include wherein the environmental sensor is a humidity sensor.

In Example 52, the subject matter of any one or more of Examples 42-51 optionally include wherein the environmental sensor is a pressure sensor.

In Example 53, the subject matter of any one or more of Examples 42-52 optionally include wherein the environmental sensor is a global positioning sensor.

In Example 54, the subject matter of any one or more of Examples 42-53 optionally include using data from the sensor to influence the grammar, semantics, or other information about how conversations are structured.

In Example 55, the subject matter of Example 54 optionally includes wherein the data from the sensor indicates an age of the user, and wherein the grammar used in the first utterance data is influenced by the age of the user.

In Example 56, the subject matter of any one or more of Examples 54-55 optionally include wherein the data from the sensor indicates a cultural background of the user, and wherein the grammar used in the first utterance data is influenced by the cultural background of the user.

In Example 57, the subject matter of any one or more of Examples 54-56 optionally include wherein the data from the sensor indicates a geographical location of the user, and wherein the grammar used in the first utterance data is influenced by the geographical location of the user.

In Example 58. the subject matter of any one or more of Examples 36-57 optionally include accessing a conversation database to assist in constructing the first utterance data consistent with conversational form.

In Example 59, the subject matter of Example 58 optionally includes wherein the conversation database includes grammar, semantics, or other information about how conversations are structured.

In Example 60, the subject matter of any one or more of Examples 36-59 optionally include wherein determining the relation between the first and second utterance data in the queue comprises accessing a training set to identify a relation between two utterance data.

In Example 61, the subject matter of any one or more of Examples 36-60 optionally include wherein determining the relation between the first and second utterance data in the queue comprises using a heuristic rule based analysis to determine the relation between two utterance data.

In Example 62, the subject matter of any one or more of Examples 36-61 optionally include wherein determining the relation between the first and second utterance data in the queue comprises using a statistical analysis to determine the relation between two utterance data.

In Example 63, the subject matter of any one or more of Examples 36-62 optionally include wherein assigning a revision strategy based on the relation comprises: accessing a rule database, a rule in the rule database including a mapping from a relation to an action; identifying the action corresponding to the relation; and assigning the corresponding action as the revision strategy.

In Example 64, the subject matter of Example 63 optionally includes wherein the relation is that there are redundant utterance data, and wherein the corresponding action is to drop one of the redundant utterance data.

In Example 65, the subject matter of any one or more of Examples 63-64 optionally include wherein the relation is that there are similar utterance data, and wherein the corresponding action is to merge the similar utterance data.

In Example 66, the subject matter of any one or more of Examples 36-65 optionally include wherein applying the revision strategy to the queue comprises removing the first utterance data from the queue when the first and second utterance data have substantially equivalent content.

In Example 67, the subject matter of any one or more of Examples 36-66 optionally include wherein applying the revision strategy to the queue comprises merging the first and second utterance data into a new utterance data and placing the new utterance data in the queue, when the first and second utterance data have substantially similar content.

In Example 68, the subject matter of any one or more of Examples 36-67 optionally include wherein applying the revision strategy to the queue comprises removing the first utterance data from the queue when the first utterance data is no longer relevant.

In Example 69, the subject matter of any one or more of Examples 36-68 optionally include wherein applying the revision strategy to the queue comprises reordering the first utterance data in the queue.

In Example 70, the subject matter of any one or more of Examples 36-69 optionally include wherein applying the revision strategy to the queue comprises moving the first utterance data to a different position in the queue and modifying the first utterance data to be consistent with when the first utterance data will be output based on the different position in the queue.

Example 71 is at least one machine-readable medium including instructions, which when executed by a machine, cause the machine to perform operations of any of the methods of Examples 36-70.

Example 72 is an apparatus comprising means for performing any of the methods of Examples 36-70.

Example 73 is an apparatus for queueing spoken dialogue output, the apparatus comprising: means for determining a relation between a first utterance data and a second utterance data in a queue; means for assigning a revision strategy based on the relation; and means for applying the revision strategy to the queue, the queue used to provide spoken dialogue output to a user.

In Example 74, the subject matter of Example 73 optionally includes means for processing text to generate the first utterance data; and means for forwarding the first utterance data to the queue.

In Example 75, the subject matter of Example 74 optionally includes means for receiving audio data of the user and processing the audio data into the text.

In Example 76, the subject matter of any one or more of Examples 74-75 optionally include means for receiving the text directly from the user as text input

In Example 77, the subject matter of any one or more of Examples 73-76 optionally include means for accessing a domain expertise utterance data; and means for adding the domain expertise utterance data to the queue as the first utterance data.

In Example 78, the subject matter of any one or more of Examples 73-77 optionally include means for accessing sensor data collected at a sensor interface, the sensor interface to collect data from a sensor; means for generating a response to a user query using the data from the sensor; and means for queueing the response in the queue as the first utterance data.

In Example 79, the subject matter of Example 78 optionally includes wherein the sensor includes at least one of: a biometric sensor or an environmental sensor.

In Example 80, the subject matter of Example 79 optionally includes wherein the biometric sensor is a heart rate sensor.

In Example 81. the subject matter of any one or more of Examples 79-80 optionally include wherein the biometric sensor is a posture sensor.

In Example 82, the subject matter of any one or more of Examples 79-81 optionally include wherein the biometric sensor is a heart rate variability sensor.

In Example 83, the subject matter of any one or more of Examples 79-82 optionally include wherein the biometric sensor is an activity sensor.

In Example 84, the subject matter of any one or more of Examples 79-83 optionally include wherein the biometric sensor is a thermometer.

In Example 85, the subject matter of any one or more of Examples 79-84 optionally include wherein the biometric sensor is a camera.

In Example 86, the subject matter of any one or more of Examples 79-85 optionally include wherein the environmental sensor is a photodetector.

In Example 87, the subject matter of any one or more of Examples 79-86 optionally include wherein the environmental sensor is a camera.

In Example 88, the subject matter of any one or more of Examples 79-87 optionally include wherein the environmental sensor is a humidity sensor.

In Example 89, the subject matter of any one or more of Examples 79-88 optionally include wherein the environmental sensor is a pressure sensor.

In Example 90. the subject matter of any one or more of Examples 79-89 optionally include wherein the environmental sensor is a global positioning sensor.

In Example 91, the subject matter of any one or more of Examples 79-90 optionally include means for using data from the sensor to influence the grammar, semantics, or other information about how conversations are structured.

In Example 92. the subject matter of Example 91 optionally includes wherein the data from the sensor indicates an age of the user, and wherein the grammar used in the first utterance data is influenced by the age of the user.

In Example 93, the subject matter of any one or more of Examples 91-92 optionally include wherein the data from the sensor indicates a cultural background of the user, and wherein the grammar used in the first utterance data is influenced by the cultural background of the user.

In Example 94, the subject matter of any one or more of Examples 91-93 optionally include wherein the data from the sensor indicates a geographical location of the user, and wherein the grammar used in the first utterance data is influenced by the geographical location of the user.

In Example 95, the subject matter of any one or more of Examples 73-94 optionally include means for accessing a conversation database to assist in constructing the first utterance data consistent with conversational form.

In Example 96, the subject matter of Example 95 optionally includes wherein the conversation database includes grammar, semantics, or other information about how conversations are structured.

In Example 97, the subject matter of any one or more of Examples 73-96 optionally include wherein the means for determining the relation between the first and second utterance data in the queue comprise means for accessing a training set to identify a relation between two utterance data.

In Example 98, the subject matter of any one or more of Examples 73-97 optionally include wherein the means for determining the relation between the first and second utterance data in the queue comprise means for using a heuristic rule based analysis to determine the relation between two utterance data.

In Example 99, the subject matter of any one or more of Examples 73-98 optionally include wherein the means for determining the relation between the first and second utterance data in the queue comprise means for using a statistical analysis to determine the relation between two utterance data.

In Example 100, the subject matter of any one or more of Examples 73-99 optionally include wherein the means for assigning a revision strategy based on the relation comprise: means for accessing a rule database, a rule in the rule database including a mapping from a relation to an action; means for identifying the action corresponding to the relation; and means for assigning the corresponding action as the revision strategy.

In Example 101, the subject matter of Example 100 optionally includes wherein the relation is that there are redundant utterance data, and wherein the corresponding action is to drop one of the redundant utterance data.

In Example 102, the subject matter of any one or more of Examples 100-101 optionally include wherein the relation is that there are similar utterance data, and wherein the corresponding action is to merge the similar utterance data.

In Example 103, the subject matter of any one or more of Examples 73-102 optionally include wherein the means for applying the revision strategy to the queue comprise means for removing the first utterance data from the queue when the first utterance data and the second utterance data have substantially equivalent content.

In Example 104, the subject matter of any one or more of Examples 73-103 optionally include wherein the means for applying the revision strategy to the queue comprise means for merging the first and second utterance data into a new utterance data and placing the new utterance data in the queue, when the first and second utterance data have substantially similar content.

In Example 105, the subject matter of any one or more of Examples 73-104 optionally include wherein the means for applying the revision strategy to the queue comprise means for removing the first utterance data from the queue when the first utterance data is no longer relevant.

In Example 106, the subject matter of any one or more of Examples 73-105 optionally include wherein the means for applying the revision strategy to the queue comprise means for reordering the first utterance data in the queue.

In Example 107, the subject matter of any one or more of Examples 73-106 optionally include wherein the means for applying the revision strategy to the queue comprise means for moving the first utterance data to a different position in the queue and modifying the first utterance data to be consistent with when the first utterance data will be output based on the different position in the queue.

Example 108 is at least one machine-readable medium including instructions for queueing spoken dialogue output, which when executed by a machine, cause the machine to: determine a relation between a first utterance data and a second utterance data in a queue; assign a revision strategy based on the relation; and apply the revision strategy to the queue, the queue used to provide spoken dialogue output to a user.

In Example 109, the subject matter of Example 108 optionally includes instructions to: process text to generate the first utterance data; and forward the first utterance data to the queue.

In Example 110, the subject matter of Example 109 optionally includes instructions to: receive audio data of the user and processing the audio data into the text.

In Example 111, the subject matter of any one or more of Examples 109-110 optionally include instructions to: receive the text directly from the user as text input.

In Example 112, the subject matter of any one or more of Examples 108-111 optionally include instructions to: access a domain expertise utterance data; and add the domain expertise utterance data to the queue as the first utterance data.

In Example 113, the subject matter of any one or more of Examples 108-112 optionally include instructions to: access sensor data collected at a sensor interface, the sensor interface to collect data from a sensor; generate a response to a user query using the data from the sensor; and queue the response in the queue as the first utterance data.

In Example 114, the subject matter of Example 113 optionally includes wherein the sensor includes at least one of: a biometric sensor or an environmental sensor.

In Example 115, the subject matter of Example 114 optionally includes wherein the biometric sensor is a heart rate sensor.

In Example 116. the subject matter of any one or more of Examples 114-115 optionally include wherein the biometric sensor is a posture sensor.

In Example 117, the subject matter of any one or more of Examples 114-116 optionally include wherein the biometric sensor is a heart rate variability sensor.

In Example 118, the subject matter of any one or more of Examples 114-117 optionally include wherein the biometric sensor is an activity sensor.

In Example 119. the subject matter of any one or more of Examples 114-118 optionally include wherein the biometric sensor is a thermometer.

In Example 120, the subject matter of any one or more of Examples 114-119 optionally include wherein the biometric sensor is a camera.

In Example 121, the subject matter of any one or more of Examples 114-120 optionally include wherein the environmental sensor is a photodetector.

In Example 122, the subject matter of any one or more of Examples 114-121 optionally include wherein the environmental sensor is a camera.

In Example 123. the subject matter of any one or more of Examples 114-122 optionally include wherein the environmental sensor is a humidity sensor.

In Example 124, the subject matter of any one or more of Examples 114-123 optionally include wherein the environmental sensor is a pressure sensor.

In Example 125, the subject matter of any one or more of Examples 114-124 optionally include wherein the environmental sensor is a global positioning sensor.

In Example 126, the subject matter of any one or more of Examples 114-125 optionally include instructions to use data from the sensor to influence the grammar, semantics, or other information about how conversations are structured.

In Example 127, the subject matter of Example 126 optionally includes wherein the data from the sensor indicates an age of the user, and wherein the grammar used in the first utterance data is influenced by the age of the user.

In Example 128, the subject matter of any one or more of Examples 126-127 optionally include wherein the data from the sensor indicates a cultural background of the user, and wherein the grammar used in the first utterance data is influenced by the cultural background of the user.

In Example 129, the subject matter of any one or more of Examples 126-128 optionally include wherein the data from the sensor indicates a geographical location of the user, and wherein the grammar used in the first utterance data is influenced by the geographical location of the user.

In Example 130, the subject matter of any one or more of Examples 108-129 optionally include instructions to access a conversation database to assist in constructing the first utterance data consistent with conversational form.

In Example 131, the subject matter of Example 130 optionally includes wherein the conversation database includes grammar, semantics, or other information about how conversations are structured.

In Example 132, the subject matter of any one or more of Examples 108-131 optionally include wherein the instructions to determine the relation between the first and second utterance data in the queue comprise instructions to access a training set to identify a relation between two utterance data.

In Example 133, the subject matter of any one or more of Examples 108-132 optionally include wherein the instructions to determine the relation between the first and second utterance data in the queue comprise instructions to use a heuristic rule based analysis to determine the relation between two utterance data.

In Example 134, the subject matter of any one or more of Examples 108-133 optionally include wherein the instructions to determine the relation between the first and second utterance data in the queue comprise instructions to use a statistical analysis to determine the relation between two utterance data.

In Example 135, the subject matter of any one or more of Examples 108-134 optionally include wherein the instructions to assign a revision strategy based on the relation comprise instructions to: access a rule database, a rule in the rule database including a mapping from a relation to an action; identify the action corresponding to the relation; and assign the corresponding action as the revision strategy.

In Example 136, the subject matter of Example 135 optionally includes wherein the relation is that there are redundant utterance data, and wherein the corresponding action is to drop one of the redundant utterance data.

In Example 137, the subject matter of any one or more of Examples 135-136 optionally include wherein the relation is that there are similar utterance data, and wherein the corresponding action is to merge the similar utterance data.

In Example 138, the subject matter of any one or more of Examples 108-137 optionally include wherein the instructions to apply the revision strategy to the queue comprise instructions to remove the first utterance data from the queue when the first and second utterance data have substantially equivalent content.

In Example 139, the subject matter of any one or more of Examples 108-138 optionally include wherein the instructions to apply the revision strategy to the queue comprise instructions to merge the first and second utterance data into a new utterance data and place the new utterance data in the queue, when the first and second utterance data have substantially similar content.

In Example 140, the subject matter of any one or more of Examples 108-139 optionally include wherein the instructions to apply the revision strategy to the queue comprise instructions to remove the first utterance data from the queue when the first utterance data is no longer relevant.

In Example 141, the subject matter of any one or more of Examples 108-140 optionally include wherein the instructions to apply the revision strategy to the queue comprise instructions to reorder the first utterance data in the queue.

In Example 142, the subject matter of any one or more of Examples 108-141 optionally include wherein the instructions to apply the revision strategy to the queue comprise instructions to move the first utterance data to a different position in the queue and modifying the first utterance data to be consistent with when the first utterance data will be output based on the different position in the queue.

Example 143 is a system for queueing spoken dialogue output, the system comprising: a first memory device including a queue; a processor subsystem; and a second memory device including instructions, which when executed on the processor subsystem, cause the processor subsystem to: determine a relation between a first utterance data and a second utterance data in the queue; assign a revision strategy based on the relation; and apply the revision strategy to the queue, the queue used to provide spoken dialogue output to a user.

In Example 144, the subject matter of Example 143 optionally includes wherein the second memory device includes instructions, which when executed on the processor subsystem, cause the processor subsystem to: access a domain expertise utterance data; and add the domain expertise utterance data to the queue as the first utterance data.

In Example 145, the subject matter of any one or more of Examples 143-144 optionally include wherein the second memory device includes instructions, which when executed on the processor subsystem, cause the processor subsystem to: process text received from a natural language understanding processor to generate the first utterance data; and forward the first utterance data to the queue.

In Example 146. the subject matter of Example 145 optionally includes wherein the text is directly received from the user as text input

In Example 147, the subject matter of any one or more of Examples 145-146 optionally include wherein the second memory device includes instructions. which when executed on the processor subsystem, cause the processor subsystem to receive audio data of the user and process the audio data into the text.

In Example 148, the subject matter of Example 147 optionally includes a sensor interface to receive data from a sensor, and wherein the second memory device includes instructions, which when executed on the processor subsystem, cause the processor subsystem to: access sensor data collected at the sensor interface; and generate a response to a user statement using the data from the sensor.

In Example 149, the subject matter of Example 148 optionally includes wherein the sensor includes at least one of: a biometric sensor or an environmental sensor.

In Example 150, the subject matter of Example 149 optionally includes wherein the biometric sensor is a heart rate sensor.

In Example 151, the subject matter of any one or more of Examples 149-150 optionally include wherein the biometric sensor is a posture sensor.

In Example 152, the subject matter of any one or more of Examples 149-151 optionally include wherein the biometric sensor is a heart rate variability sensor.

In Example 153, the subject matter of any one or more of Examples 149-152 optionally include wherein the biometric sensor is an activity sensor.

In Example 154, the subject matter of any one or more of Examples 149-153 optionally include wherein the biometric sensor is a thermometer.

In Example 155. the subject matter of any one or more of Examples 149-154 optionally include wherein the biometric sensor is a camera.

In Example 156, the subject matter of any one or more of Examples 149-155 optionally include wherein the environmental sensor is a photodetector.

In Example 157, the subject matter of any one or more of Examples 149-156 optionally include wherein the environmental sensor is a camera.

In Example 158, the subject matter of any one or more of Examples 149-157 optionally include wherein the environmental sensor is a humidity sensor.

In Example 159, the subject matter of any one or more of Examples 149-158 optionally include wherein the environmental sensor is a pressure sensor.

In Example 160, the subject matter of any one or more of Examples 149-159 optionally include wherein the environmental sensor is a global positioning sensor.

In Example 161, the subject matter of any one or more of Examples 149-160 optionally include wherein the dialogue manager uses data from the sensor to influence the grammar, semantics, or other information about how conversations are structured.

In Example 162, the subject matter of Example 161 optionally includes wherein the data from the sensor indicates an age of the user, and wherein the grammar used in the first utterance data is influenced by the age of the user.

In Example 163, the subject matter of any one or more of Examples 161-162 optionally include wherein the data from the sensor indicates a cultural background of the user, and wherein the grammar used in the first utterance data is influenced by the cultural background of the user.

In Example 164, the subject matter of any one or more of Examples 161-163 optionally include wherein the data from the sensor indicates a geographical location of the user, and wherein the grammar used in the first utterance data is influenced by the geographical location of the user.

In Example 165, the subject matter of any one or more of Examples 143-164 optionally include wherein the second memory device includes instructions, which when executed on the processor subsystem, cause the processor subsystem to access a conversation database to assist in constructing an output utterance data consistent with conversational form.

In Example 166, the subject matter of Example 165 optionally includes wherein the conversation database includes grammar, semantics, or other information about how conversations are structured.

In Example 167, the subject matter of any one or more of Examples 143-166 optionally include wherein to determine the relation between the first and second utterance data in the queue, the processor subsystem is to access a training set to identify a relation between two utterance data.

In Example 168, the subject matter of any one or more of Examples 143-167 optionally include wherein to determine the relation between the first and second utterance data in the queue, the processor subsystem is to use a heuristic rule based analysis to determine the relation between two utterance data.

In Example 169, the subject matter of any one or more of Examples 143-168 optionally include wherein to determine the relation between the first and second utterance data in the queue, the processor subsystem is to use a statistical analysis to determine the relation between two utterance data.

In Example 170, the subject matter of any one or more of Examples 143-169 optionally include wherein the instructions to assign a revision strategy based on the relation includes instructions, which when executed on the processor subsystem, cause the processor subsystem to: access a rule database, a rule in the rule database including a mapping from a relation to an action; identify the action corresponding to the relation; and assign the corresponding action as the revision strategy.

In Example 171, the subject matter of Example 170 optionally includes wherein the relation is that there are redundant utterance data, and wherein the corresponding action is to drop one of the redundant utterance data.

In Example 172, the subject matter of any one or more of Examples 170-171 optionally include wherein the relation is that there are similar utterance data, and wherein the corresponding action is to merge the similar utterance data.

In Example 173, the subject matter of any one or more of Examples 143-172 optionally include wherein the instructions to apply the revision strategy to the queue includes instructions, which when executed on the processor subsystem, cause the processor subsystem to remove the first utterance data from the queue when the first and second utterance data have substantially equivalent content.

In Example 174, the subject matter of any one or more of Examples 143-173 optionally include wherein the instructions to apply the revision strategy to the queue includes instructions, which when executed on the processor subsystem, cause the processor subsystem to merge first and the second utterance data into a new utterance data and place the new utterance data in the queue, when the first and the second utterance data have substantially similar content.

In Example 175, the subject matter of any one or more of Examples 143-174 optionally include wherein the instructions to apply the revision strategy to the queue includes instructions, which when executed on the processor subsystem, cause the processor subsystem to remove the first utterance data from the queue when the first utterance data is no longer relevant.

In Example 176, the subject matter of any one or more of Examples 143-175 optionally include wherein the instructions to apply the revision strategy to the queue includes instructions, which when executed on the processor subsystem, cause the processor subsystem to reorder the first utterance data in the queue.

In Example 177, the subject matter of any one or more of Examples 143-176 optionally include wherein the instructions to apply the revision strategy to the queue includes instructions, which when executed on the processor subsystem, cause the processor subsystem to move the first utterance data to a different position in the queue and modify the first utterance data to be consistent with when the first utterance data will be output based on the different position in the queue.

Example 178 is at least one machine-readable medium including instructions. which when executed by a machine, cause the machine to perform operations of any of the operations of Examples 1-177.

Example 179 is an apparatus comprising means for performing any of the operations of Examples 1-177.

Example 180 is a system to perform the operations of any of the Examples 1-177.

Example 181 is a method to perform the operations of any of the Examples 1-177.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document, for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A.” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third.” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further. embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for queueing spoken dialogue output, the system comprising:
an output manager to:
determine a relation between a first utterance and a second utterance in a queue;
assign a revision strategy based on the relation; and
apply the revision strategy to the queue, the queue used to provide spoken dialogue output to a user.

2. The system of claim 1, further comprising:
a dialogue manager to:
access a domain expertise utterance; and
add the domain expertise utterance to the queue as the first utterance.

3. The system of claim 1, further comprising:
a dialogue manager to:
process text received from a natural language understanding processor to generate the first utterance; and
forward the first utterance to the queue.

4. The system of claim 3, wherein the text is directly received from the user as text input.

5. The system of claim 3, further comprising:
the natural language understanding processor to receive audio data of the user and process the audio data into the text.

6. The system of claim 5, wherein the natural language processor is to:
access sensor data collected at a sensor interface, the sensor interface to collect data from a sensor; and
generate a response to a user statement using the data from the sensor.

7. A method of queueing spoken dialogue output, the method comprising:
determining a relation between a first utterance and a second utterance in a queue;
assigning a revision strategy based on the relation; and
applying the revision strategy to the queue, the queue used to provide spoken dialogue output to a user.

8. The method of claim 7, further comprising:
processing text to generate the first utterance; and
forwarding the first utterance to the queue.

9. The method of claim 7, further comprising:
accessing a domain expertise utterance; and
adding the domain expertise utterance to the queue as the first utterance.

10. The method of claim 7, further comprising:
accessing sensor data collected at a sensor interface, the sensor interface to collect data from a sensor;
generating a response to a user query using the data from the sensor; and
queueing the response in the queue as the first utterance.

11. At least one machine-readable medium including instructions for queueing spoken dialogue output, which when executed by a machine, cause the machine to:
determine a relation between a first utterance and a second utterance in a queue;
assign a revision strategy based on the relation; and
apply the revision strategy to the queue, the queue used to provide spoken dialogue output to a user.

12. The at least one machine-readable medium of claim 11, further comprising instructions to:
process text to generate the first utterance; and
forward the first utterance to the queue.

13. The at least one machine-readable medium of claim 12, further comprising instructions to:
receive audio data of the user and processing the audio data into the text.

14. The at least one machine-readable medium of claim 12, further comprising instructions to:
receive the text directly from the user as text input.

15. The at least one machine-readable medium of claim 11, further comprising instructions to:
access a domain expertise utterance; and
add the domain expertise utterance to the queue as the first utterance.

16. The at least one machine-readable medium of claim 11, further comprising instructions to:
access sensor data collected at a sensor interface, the sensor interface to collect data from a sensor;
generate a response to a user query using the data from the sensor; and
queue the response in the queue as the first utterance.

17. A system for queueing spoken dialogue output, the system comprising:
a first memory device including a queue;
a processor subsystem; and
a second memory device including instructions, which when executed on the processor subsystem, cause the processor subsystem to:
determine a relation between a first utterance data and a second utterance data in the queue;
assign a revision strategy based on the relation; and
apply the revision strategy to the queue, the queue used to provide spoken dialogue output to a user.

18. The system of claim 17, wherein the second memory device includes instructions, which when executed on the processor subsystem, cause the processor subsystem to:
access a domain expertise utterance data; and
add the domain expertise utterance data to the queue as the first utterance data.

19. The system of claim 17, wherein the second memory device includes instructions, which when executed on the processor subsystem, cause the processor subsystem to:
process text received from a natural language understanding processor to generate the first utterance data; and
forward the first utterance data to the queue.

20. The system of claim 19, wherein the second memory device includes instructions, which when executed on the processor subsystem, cause the processor subsystem to receive audio data of the user and process the audio data into the text.

21. The system of claim 21, further comprising a sensor interface to receive data from a sensor, and wherein the second memory device includes instructions, which when executed on the processor subsystem, cause the processor subsystem to:
access sensor data collected at the sensor interface; and
generate a response to a user statement using the data from the sensor.

22. The system of claim 17, wherein to determine the relation between the first and second utterance data in the queue, the processor subsystem is to access a training set to identify a relation between two utterance data.

23. The system of claim 17, wherein to determine the relation between the first and second utterance data in the queue, the processor subsystem is to use a heuristic rule based analysis to determine the relation between two utterance data.

24. The system of claim 17, wherein to determine the relation between the first and second utterance data in the queue, the processor subsystem is to use a statistical analysis to determine the relation between two utterance data.

25. The system of claim 17, wherein the instructions to assign a revision strategy based on the relation includes instructions, which when executed on the processor subsystem, cause the processor subsystem to:
access a rule database, a rule in the rule database including a mapping from a relation to an action;
identify the action corresponding to the relation; and
assign the corresponding action as the revision strategy.
